(19) United States
(12) Patent Application Publication
(10) Pub. No.: US 2021/0224310 A1
(43) Pub. Date: Jul. 22, 2021

(54) ELECTRONIC DEVICE AND STORY GENERATION METHOD THEREOF

(71) Applicant: Samsung Electronics Co., Ltd., Gyeonggi-do (KR)

(72) Inventors: Dmytro ZHELEZNIAKOV, Kyiv (UA); Oleksandr MARCHENKO, Kyiv (UA); Ivan DERIUGA, Kyiv (UA); Olga RADYVONENKO, Kyiv (UA); Pavlo TYTARCHUK, Kyiv (UA); Valentyna VOLKOVA, Kyiv (UA); Viktor ZAYTSEV, Kyiv (UA); Tetiana IGNATOVA, Kyiv (UA)

(21) Appl. No.: 17/149,383

(22) Filed: Jan. 14, 2021

(30) Foreign Application Priority Data
Jan. 22, 2020 (KR) 10-2020-0008891

(51) Int. Cl. G06F 16/483; G06K 9/00

(52) U.S. Cl. CPC G06F 16/483; G06K 9/00677; G06K 9/00718

(57) ABSTRACT

Provided is an electronic device which may include a processor configured to extract objects from at least one image and/or video; analyze information related to the objects extracted from the at least one image and/or video; select the style of a story to be generated based on the extracted objects and the analyzed information; generate the story by using the extracted objects and the analyzed information; and change an object included in the generated story into the selected style.

### CROSS-REFERENCE TO RELATED APPLICATION(S)

This application is based on and claims priority under 35 U.S.C. § 119 to Korean Patent Application No. 10-2020-0008891, filed on Jan. 22, 2020, in the Korean Intellectual Property Office, the disclosure of which is incorporated by reference herein in its entirety.

### BACKGROUND

### 1. Field

The present disclosure generally relates to an electronic device capable of generating a story and a method of operating the same.

### 2. Description of Related Art

With the development of electronic devices such as smart phones, people are using electronic devices more for text messages, video viewing, and games than for phone calls. Recently, electronic devices are being widely used to utilize social networks or social media such as Facebook, Instagram, and Twitter.

In such a social network, videos and images may be registered along with a short description or sentence. Social networks may provide opportunities to communicate with others around the world. To interact more with others, people may upload a variety of articles, images, and videos, and may communicate with each other through posted articles, images, and videos.

### SUMMARY

An aspect of the disclosure is to provide a method for an electronic device to generate a short story for at least one image and/or video even if the user does not directly write a story.

According to an embodiment, the electronic device may generate a creative story for a specific image rather than simply generating a descriptive story.

According to an embodiment, there is provided an electronic device. The electronic device may include a processor configured to extract objects from at least one image and/or video; analyze information related to the objects extracted from the at least one image and/or video; select a style of a story to be generated based on the extracted objects and the analyzed information; generate the story by using the extracted objects and the analyzed information; and change an object included in the generated story into the selected style.

According to an embodiment, there is provided an electronic device. The electronic device may include a processor configured to extract objects from at least one image and/or video; analyze information related to the objects extracted from the at least one image and/or video; select a style of a story to be generated based on the extracted objects and the analyzed information; change the extracted objects and the analyzed information into the selected style; and generate the story by using the changed objects and information.

According to an embodiment, there is provided a method of story generation for an electronic device. The method may include extracting objects from at least one image and/or video; analyzing information related to the objects extracted from the at least one image and/or video; selecting a style of a story to be generated based on the extracted objects and the analyzed information; generating the story by using the extracted objects and the analyzed information; and changing an object included in the generated story into the selected style.

According to an embodiment, there is provided a method of story generation for an electronic device. The method may include extracting objects from at least one image and/or video; analyzing information related to the objects extracted from the at least one image and/or video; selecting a style of a story to be generated based on the extracted objects and the analyzed information; changing the extracted objects and the analyzed information into the selected style; and generating the story by using the changed objects and information.

### BRIEF DESCRIPTION OF THE DRAWINGS

The above and other aspects, features and advantages of certain embodiments of the disclosure will be more apparent from the following detailed description, taken in conjunction with the accompanying drawings, in which:

FIG. 1 is a block diagram of an electronic device in a network environment according to various embodiments;

FIG. 2 illustrates a hierarchical structure of programs according to various embodiments;

FIGS. 3A and 3B are a flowchart for an electronic device to generate a story or/and a caption from at least one image according to an embodiment;

FIGS. 4A and 4B illustrate an image and objects for which the electronic device generates a story according to an embodiment;

FIG. 5 illustrates a semantic graph representing a relationship between objects extracted from the image according to an embodiment;

FIG. 6 illustrates a semantic graph representing a positional relationship between objects extracted from the image according to an embodiment;

FIG. 7 illustrates a semantic graph representing an emotional clue of an object extracted from the image according to an embodiment,

FIG. 8 illustrates a semantic graph representing a scenic relationship of the image according to an embodiment;

FIG. 9 illustrates a semantic graph representing a subjective relationship between objects extracted from the image according to an embodiment;

FIG. 10 illustrates a semantic graph representing a contextual relationship of the image according to an embodiment,

FIG. 11 depicts a scheme that is used by the electronic device to derive a style to be proposed through an analysis of the image according to an embodiment;

FIG. 12 illustrates a semantic graph showing a case where weights are considered by the electronic device according to an embodiment;

FIGS. 13A and 13B are diagrams in which the electronic device generates various stories according to an embodiment; and

FIG. 14 shows an example of changing a generated story into a selected style according to an embodiment.

### DETAILED DESCRIPTION

Hereinafter, various embodiments of the disclosure will be described in detail with reference to accompanying drawings.

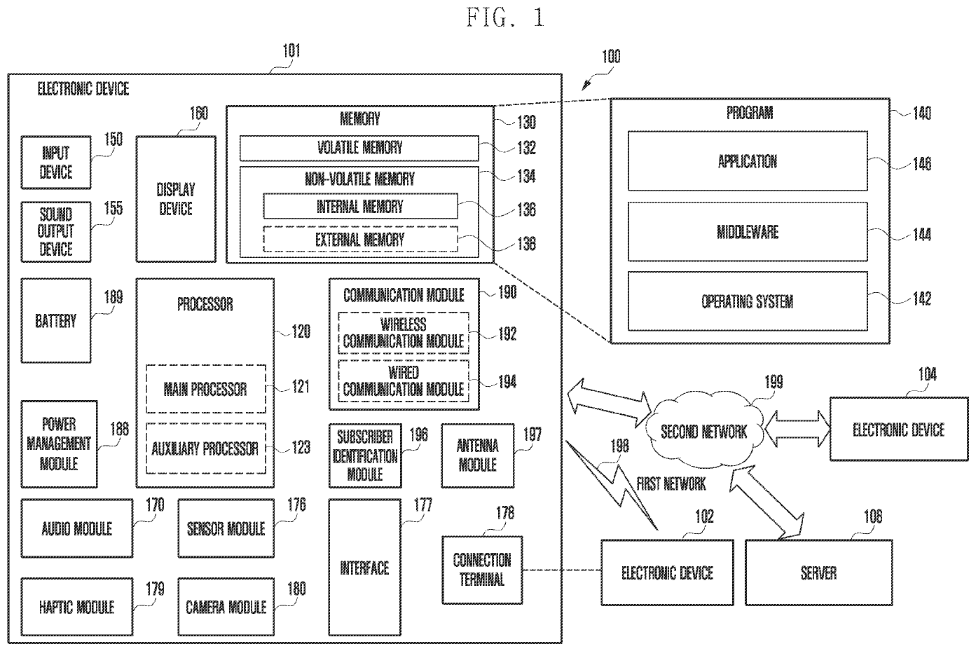

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an ISP or a CP) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, a keyboard, or a digital pen (e.g., a stylus pen).

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, ISPs, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently from the processor 120 (e.g., the AP) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., PCB). According to an embodiment, the antenna module 197 may include a plurality of antennas. In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

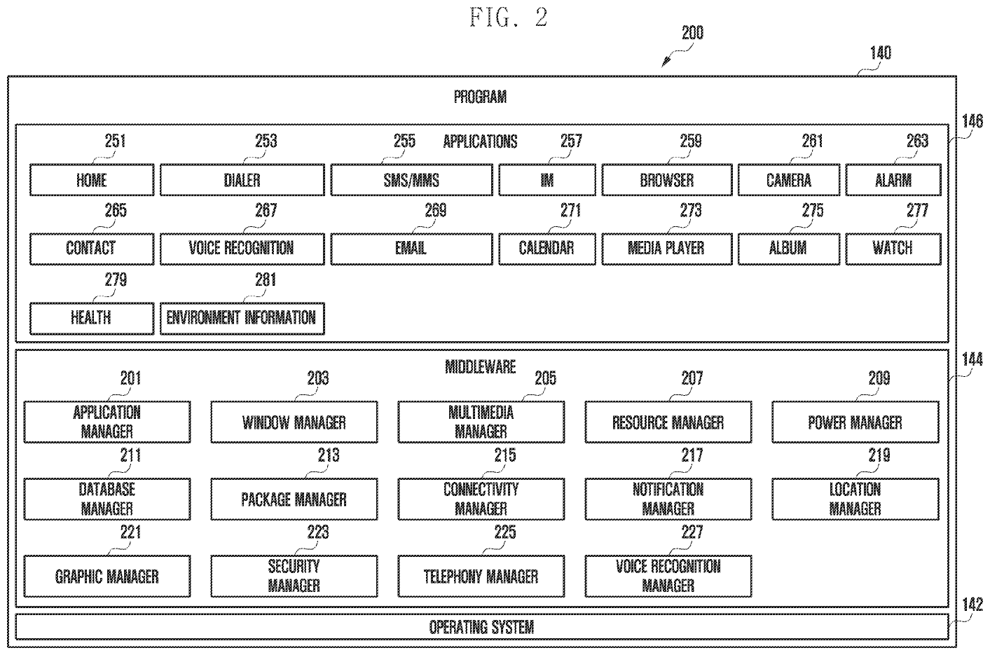

FIG. 2 is a block diagram 200 illustrating the program 140 according to various embodiments.

According to an embodiment, the program 140 may include an operating system (OS) 142 to control one or more resources of the electronic device 101, middleware 144, or an application 146 executable in the OS 142. The OS 142 may include, for example, Android™, iOS™, Windows™, Symbian™, Tizen™, or Bada™ At least part of the program 140, for example, may be pre-loaded on the electronic device 101 during manufacture, or may be downloaded from or updated by an external electronic device (e.g., the electronic device 102 or 104, or the server 108) during use by a user.

The OS 142 may control management (e.g., allocating or deallocation) of one or more system resources (e.g., process, memory, or power source) of the electronic device 101. The OS 142, additionally or alternatively, may include one or more driver programs to drive other hardware devices of the electronic device 101, for example, the input device 150, the sound output device 155, the display device 160, the audio module 170, the sensor module 176, the interface 177, the haptic module 179, the camera module 180, the power management module 188, the battery 189, the communication module 190, the subscriber identification module 196, or the antenna module 197.

The middleware 144 may provide various functions to the application 146 such that a function or information provided from one or more resources of the electronic device 101 may be used by the application 146. The middleware 144 may include, for example, an application manager 201, a window manager 203, a multimedia manager 205, a resource manager 207, a power manager 209, a database manager 211, a package manager 213, a connectivity manager 215, a notification manager 217, a location manager 219, a graphic manager 221, a security manager 223, a telephony manager 225, or a voice recognition manager 227.

The application manager 201, for example, may manage the life cycle of the application 146. The window manager 203, for example, may manage one or more graphical user interface (GUI) resources that are used on a screen. The multimedia manager 205, for example, may identify one or more formats to be used to play media files, and may encode or decode a corresponding one of the media files using a codec appropriate for a corresponding format selected from the one or more formats. The resource manager 207, for example, may manage the source code of the application 146 or a memory space of the memory 130. The power manager 209, for example, may manage the capacity, temperature, or power of the battery 189, and determine or provide related information to be used for the operation of the electronic device 101 based at least in part on corresponding information of the capacity, temperature, or power of the battery 189. According to an embodiment, the power manager 209 may interwork with a basic input/output system (BIOS) (not shown) of the electronic device 101.

The database manager 211, for example, may generate, search, or change a database to be used by the application 146. The package manager 213, for example, may manage installation or update of an application that is distributed in the form of a package file. The connectivity manager 215, for example, may manage a wireless connection or a direct connection between the electronic device 101 and the external electronic device. The notification manager 217, for example, may provide a function to notify a user of an occurrence of a specified event (e.g., an incoming call, message, or alert). The location manager 219, for example, may manage locational information on the electronic device 101. The graphic manager 221, for example, may manage one or more graphic effects to be offered to a user or a user interface related to the one or more graphic effects.

The security manager 223, for example, may provide system security or user authentication. The telephony manager 225, for example, may manage a voice call function or a video call function provided by the electronic device 101. The voice recognition manager 227, for example, may transmit a user's voice data to the server 108, and receive, from the server 108, a command corresponding to a function to be executed on the electronic device 101 based at least in part on the voice data, or text data converted based at least in part on the voice data. According to an embodiment, the middleware 244 may dynamically delete some existing components or add new components. According to an embodiment, at least part of the middleware 144 may be included as part of the OS 142 or may be implemented as another software separate from the OS 142.

The application 146 may include, for example, a home 251, dialer 253, short message service (SMS)/multimedia messaging service (MMS) 255, instant message (IM) 257, browser 259, camera 261, alarm 263, contact 265, voice recognition 267, email 269, calendar 271, media player 273, album 275, watch 277, health 279 (e.g., for measuring the degree of workout or biometric information, such as blood sugar), or environmental information 281 (e.g., for measuring air pressure, humidity, or temperature information) application. According to an embodiment, the application 146 may further include an information exchanging application that is capable of supporting information exchange between the electronic device 101 and the external electronic device. The information exchange application, for example, may include a notification relay application adapted to transfer designated information (e.g., a call, message, or alert) to the external electronic deviceoradevice management application adapted to manage the external electronic device. The notification relay application may transfer notification information corresponding to an occurrence of a specified event (e.g., receipt of an email) at another application (e.g., the email application 269) of the electronic device 101 to the external electronic device. Additionally or alternatively, the notification relay application may receive notification information from the external electronic device and provide the notification information to a user of the electronic device 101.

The device management application may control the power (e.g., turn-on or turn-off) or the function (e.g., adjustment of brightness, resolution, or focus) of the external electronic device or some component thereof (e.g., a display device or a camera module of the external electronic device). The device management application, additionally or alternatively, may support installation, delete, or update of an application running on the external electronic device.

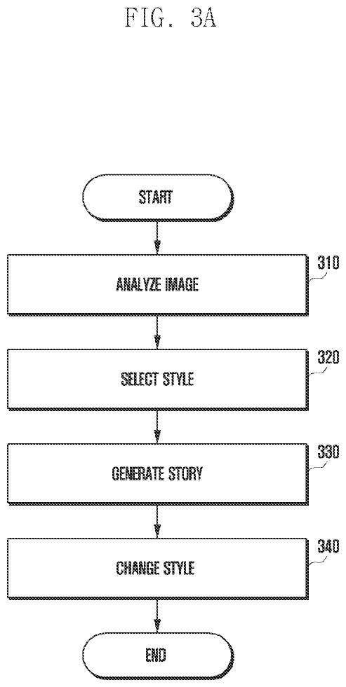

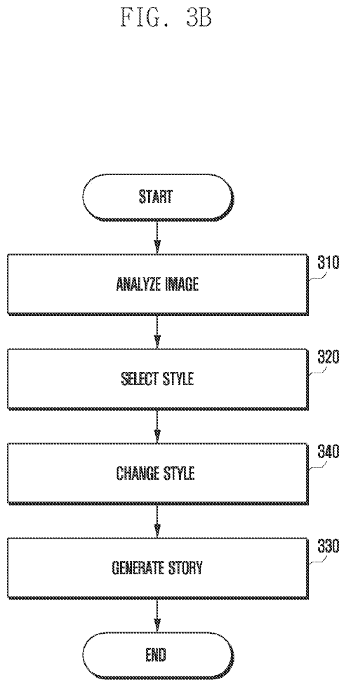

FIGS. 3A and 3B are a flowchart for an electronic device to generate a story or/and a caption from at least one image according to an embodiment.

The electronic device 101 may analyze a selected image at step 310. The image can be selected by the user, or the image may be selected by a program or application. For example, when the user specifies a date and place, an image created at the specified place on the specified date may be selected.

One image may be selected, or many images may be selected. In addition, a video other than an image may be selected, or both an image and a video may also be selected. Hereinafter, a case in which one image is selected will be described as an example, but the disclosure is not limited thereto.

The electronic device 101 may generate a semantic graph or/and a parse tree by analyzing the selected image. The semantic graph may represent objects included in the image. For example, the semantic graph may include information about connections between objects included in the image, relationships between objects, and positions of objects in the image. The parse tree may represent an object included in the image in a sentence structure regardless of grammar. The parse tree can be formed differently depending on the language used to generate the story. For example, when the story is generated in English, the parse tree may be created according to the sentence structure of English. When the story is generated in Korean, the parse tree may be created according to the sentence structure of Korean. Alternatively, after the parse tree is generated according to the sentence structure of a preset language, it may be translated after the story is generated. In an embodiment, the electronic device 101 may use a semantic graph to analyze an image and may use a parse tree to transform the style, without being limited thereto.

A method for the electronic device 101 to generate a semantic graph or a parse (syntax) tree according to an embodiment will hereinafter be described.

Referring to FIGS. 3A and 3B, the electronic device 101 may select a style for the selected image at step 320. The electronic device 101 may analyze objects included in the image and propose a plurality of styles to the user. The electronic device 101 may propose a style to the user in consideration of information on the object analyzed using a semantic graph. The user may select one of the styles proposed by the electronic device 101, or when selecting an image, the user may also select a style. Alternatively, after the electronic device 101 selects a specific style, the style may be changed according to the user's selection.

The electronic device 101 may generate a story (e.g., coherent story) by using extracted objects and analyzed information at step 330.

The electronic device 101 may change an object included in the generated story into the selected style at step 340. For example, if a boy is included in the generated story and the selected style is “fantasy”, the boy can be changed into a knight. As another example, if the weather is analyzed as “clear” in the generated story, it may be changed into “good day to go on a picnic” (e.g., when “romantic” is selected as the style) or “sunny day” (e.g., when “description” is selected as the style) depending on the selected style. The generated story may be simply expressed or may be expressed in a number of sentences as a paragraph, depending on the style to be changed.

The electronic device 101 may change the style by replacing words only in an already generated story.

In FIG. 3A, a story is generated using objects extracted from an image and then the style is changed. However, in FIG. 3B, the style is changed for objects extracted from an image and then a story is generated.

In addition, the electronic device 101 may generate a story without being limited to the order described in FIG. 3A or FIG. 3B. FIG. 3B is identical to FIG. 3A, except the order of step 330 and step 340 is reversed.

Next, a detailed description is given of a process of generating a story by using one image as an example according to an embodiment of the disclosure.

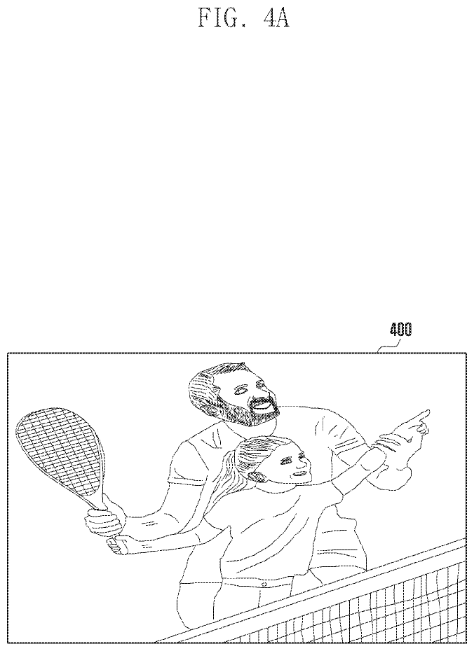

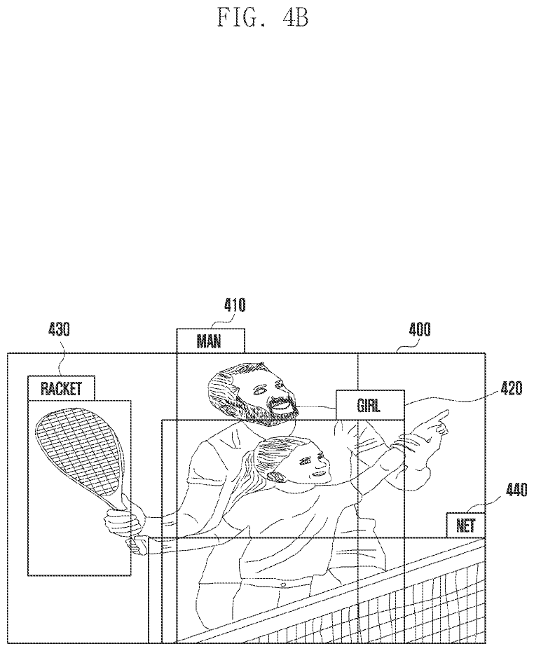

FIGS. 4A and 4B illustrate an image and objects for which the electronic device generates a story according to an embodiment.

In an embodiment, the electronic device 101 may extract objects from the image 400, which may be selected by the user, or may be selected by a program or application.

FIG. 4A illustrates an image 400 for which the electronic device 101 generates a story according to an embodiment, and FIG. 4B shows objects extracted by the electronic device 101 from the image 400.

With reference to FIG. 4B, the electronic device 101 may extract a man 410, a girl 420, a racket 430, and a net 440 from the image 400. In addition, the electronic device 101 may further extract a tennis court and grass.

The electronic device 101 may infer a sport, such as tennis, from the racket 430 and the net 440.

The electronic device 101 may also detect the relationship between extracted objects and location information in the image. For example, in FIG. 4B, the electronic device 101 may detect that the man 410 and girl 420 are located at the center of the image. The electronic device 101 may infer that the man 410 and the girl 420 are holding the racket 430 together from the shape, direction, and position of the hands. The electronic device 101 may infer that the man 410 and the girl 420 are looking at the same place from the directions of their faces. In addition, the electronic device 101 may infer emotions from the shapes of eyes and mouths of the man 410 and the girl 420.

The electronic device 101 may infer the scene from the presence or absence of lighting and the types of extracted objects. For example, if there is no lighting and a tree is detected, the electronic device 101 may infer (or determine) an outdoor scene. As another example, if many parts of the image are white and a snowman is detected, the electronic device 101 may infer an outdoor scene in winter.

Next, a description is given of a process for the electronic device 101 to create a semantic graph by using objects extracted from an image and analysis information to generate a story according to an embodiment of the disclosure. Herein, the semantic graph (or semantic network) may represent extracted objects and relationships therebetween. For example, the semantic graph may represent a spatial positional relationship between objects (e.g., front, back, top or side). The semantic graph may represent a subjective relationship between objects (e.g., parent-child, husband and wife, co-worker, or group member).

When the relationship between extracted objects is represented in a semantic graph, the user can readily understand the relationship. Using a semantic graph, the electronic device 101 can easily express the relationship between objects in a language. Using a semantic graph, the electronic device 101 can efficiently represent the relationship between individual objects. Using a semantic graph, the electronic device 101 can expand the story in an easy and simple manner.

In various embodiments, semantic graphs can be created by using representations stored in a database.

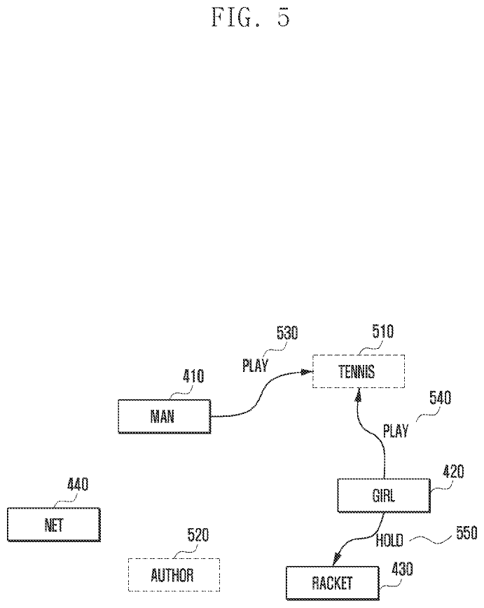

FIG. 5 illustrates a semantic graph representing a semantic relationship between objects extracted from the image according to an embodiment.

The electronic device 101 may generate a semantic relationship between objects by using the extracted objects.

With reference to FIGS. 4B and 5, the electronic device 101 may extract a man 410, a girl 420, a racket 430, and a net 440 from the image 400.

The electronic device 101 may infer tennis 510 from the racket 430 and the net 440. From the size of the person included in the image 400, the electronic device 101 may infer that the image 400 has been created by an external person (e.g., author 520) other than the person included in the image 400. Alternatively, the electronic device 101 may determine that the image 400 has been created by the owner of the electronic device on the grounds that the owner of the electronic device is not included in the image 400.

as the man 410 and the girl 420 are near the net 440, the electronic device 101 may infer that the man 410 and the girl 420 play tennis 510 (530 and 540).

In various embodiments of the disclosure, the electronic device 101 may detect that the girl 420 is holding the racket 430 (550) in the image 400. From this, the electronic device 101 may also infer that the man 410 and the girl 420 play tennis 510 (530 and 540).

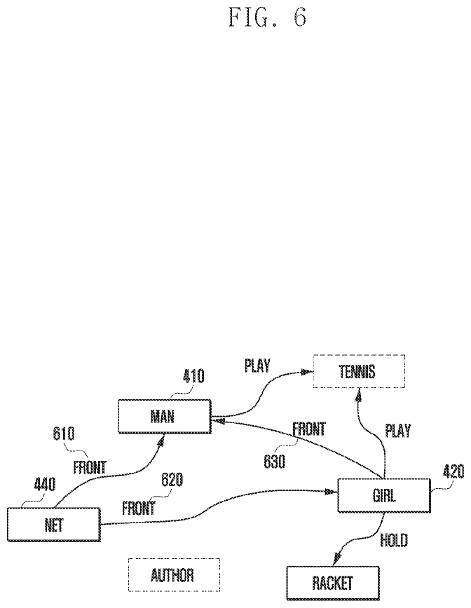

FIG. 6 illustrates a semantic graph representing a positional relationship between objects extracted from the image according to an embodiment.

The electronic device 101 may analyze a positional relationship between extracted objects.

With reference to FIGS. 4B and 6, the electronic device 101 may detect that the man 410 and the girl 420 are located in front of the net 440 (610 and 620). The electronic device 101 may also detect that the girl 420 is located in front of the man 410 (630).

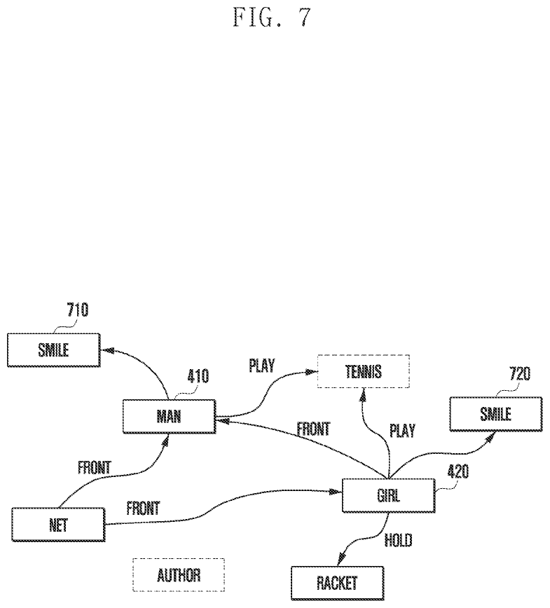

FIG. 7 illustrates a semantic graph representing an emotional clue of an object extracted from the image according to an embodiment.

The electronic device 101 may analyze the emotion of a person or an animal selected from among the extracted objects.

With reference to FIGS. 4B and 7, the electronic device 101 may detect that the man 410 and the girl 420 are smiling (710 and 720) in the image 400. For example, the electronic device 101 may infer the emotion of a person based on the shape of the mouth and wrinkles on the face. The electronic device 101 may infer that a person smiles when both sides of the mouth are raised or when the mouth opens and the eyes become half-moon-shaped. Alternatively, the electronic device 101 may infer that people are angry when they look at different places or when their mouths are tightly closed.

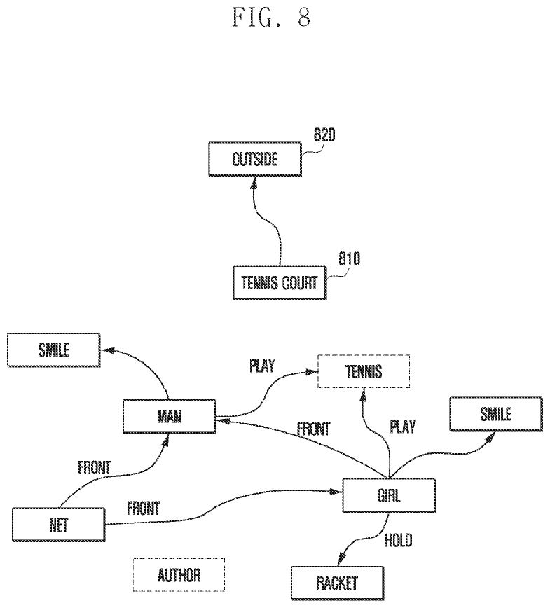

FIG. 8 illustrates a semantic graph representing a scenic relationship of the image according to an embodiment.

The electronic device 101 may selectively analyze a scene of the image.

With reference to FIGS. 4B and 8, the electronic device 101 may further extract a tennis court 810. As the tennis court 810 is generally located outdoors, the electronic device 101 may infer that the image 400 is related to the outside 820. The electronic device 101 may infer the scene by further considering the determined type of sport and the type of the extracted object.

As another example, when water is detected, the electronic device 101 may infer that the image is related to a beach, a riverside, or a swimming pool.

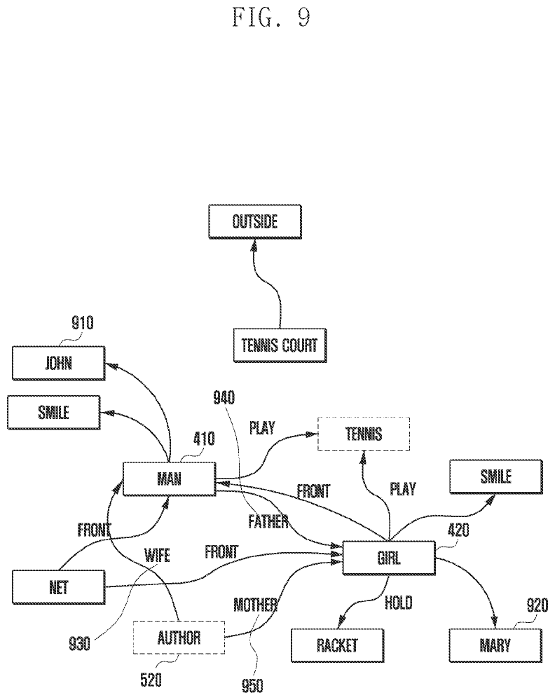

FIG. 9 illustrates a semantic graph representing a subjective relationship between objects extracted from the image according to an embodiment.

The electronic device 101 may analyze a subjective relationship between selectively extracted objects. For example, if the extracted objects are a person or an animal, the electronic device 101 may analyze a subjective relationship between the extracted objects.

The electronic device 101 may infer that the man 410 is John 910 based on another image. The electronic device 101 may infer that the girl 420 is Mary 920 based on another image.

The electronic device 101 may infer that the author 520 of the image 400 is the owner of the electronic device 101. The electronic device 101 may analyze the relationship between the author 520 and an extracted object by using another image. For example, the electronic device 101 may detect that the author 520 and the man 410 are in a marital relationship, and thus may infer that the author 520 is the wife of the man 410 (930). The electronic device 101 may also analyze the relationship between the author 520 and the girl 420. For example, the electronic device 101 may detect that the author 520 is the mother of the girl 420 (950). In addition, the electronic device 101 may analyze whether a person included in the image is socially famous. The electronic device 101 may determine this by comparing an image of the detected person with images of famous people stored in a database. The electronic device 101 may analyze an object larger than a certain size only, or may analyze an object occupying a certain part of the image only.

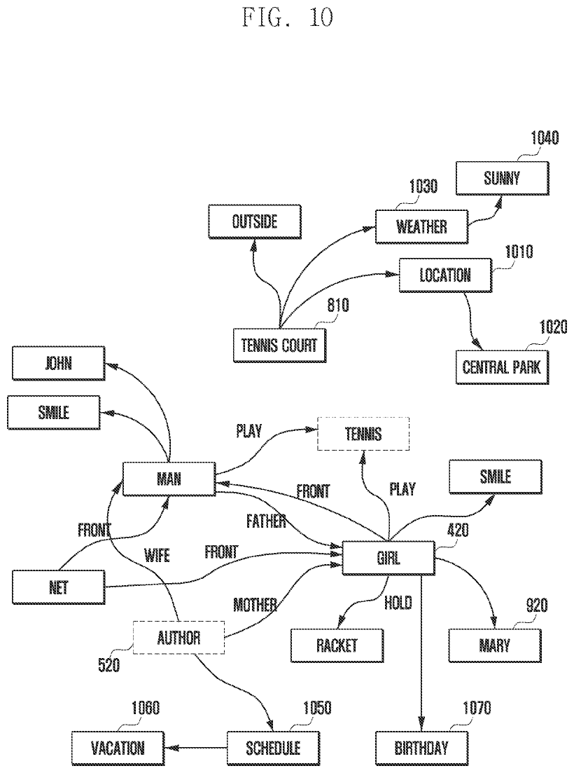

FIG. 10 illustrates a semantic graph representing a contextual relationship of the image according to an embodiment.

The electronic device 101 may selectively analyze the context of the image 400.

The electronic device 101 may analyze the location 1010 in relation to the tennis court 810 being an extracted object. For example, the electronic device 101 may infer that the location of the tennis court 810 is a central park 1020 based on another image. As another example, the electronic device 101 may infer that the location of the tennis court 810 is the central park 1020 based on global positioning system (GPS) information produced at the time of image generation. For example, an image may separately include information related to image generation, such as creation date, creation location, and the electronic device used to generate the image. The electronic device 101 may further analyze the context of the image by using this information.

The electronic device 101 may analyze the weather 1030 in relation to the tennis court 810 being an extracted object. For example, the electronic device 101 may analyze the location of the tennis court 810 and the brightness of the image 400 to infer that the weather 1030 in the image 400 is sunny (1040). Alternatively, the electronic device 101 may further analyze weather information based on the image creation date and location information.

The electronic device 101 may further analyze the author 520. For example, the electronic device 101 may refer to the schedule 1050 of the author 520 by using installed calendar and/or diary applications. The electronic device 101 may infer that the date on which the image 400 is generated belongs to a vacation 1060 based on the schedule 1050. The electronic device 101 may detect that the date on which the image 400 is generated is the birthday 1070 of the girl 420.

In order to analyze the extracted objects, the electronic device 101 may further use at least one of the metadata of the image 400, a social network, or the profile of the user (e.g., owner of the electronic device 101). For example, information on a location or place, a city, a country, or a specific region may be used to analyze a relationship with an extracted object. Date and season information can also be used to analyze a relationship with an extracted object.

Furthermore, the electronic device 101 may determine whether the creation date of the image is a specific anniversary of the user and use the result to analyze the image.

The electronic device 101 may also use information related to weather to analyze the image. If an umbrella is included in the image, the electronic device 101 may infer rainy weather.

The electronic device 101 may also use events related to the schedule and/or calendar for image analysis. For example, using information included in a schedule related application, the electronic device 101 may determine whether there is a meeting, a trip, or a vacation. As another example, the electronic device 101 may infer a birthday, an anniversary, and a date based on information included in the calendar.

The electronic device 101 may use information included in the contacts of the electronic device 101 for image analysis. For example, if a person listed in the contacts is included in the image, the electronic device 101 may use information related to the occupation, birthday, group, and work of the person for image analysis.

The electronic device 101 may also use information measured through a health sensor. For example, if the image is related to an exercise, the electronic device 101 may analyze the image by further using information on the heart rate and the number of steps.

Additionally, the electronic device 101 may analyze whether a celebrity is included in the image. If the electronic device 101 analyzes a video, it may analyze sounds as well as images.

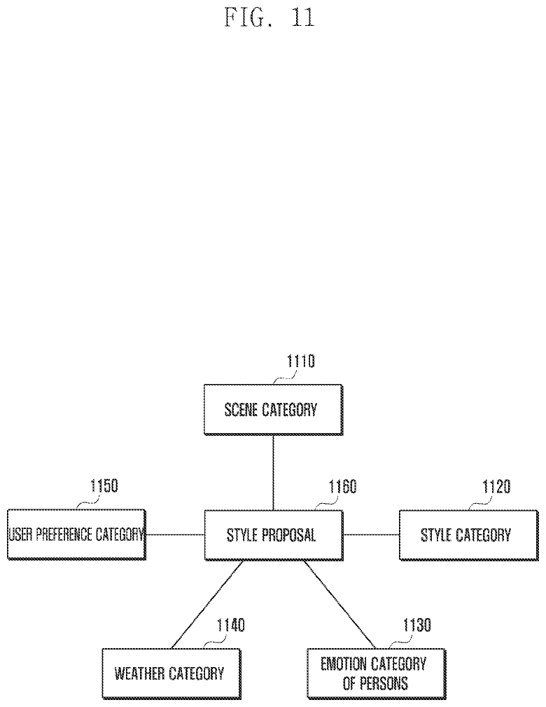

FIG. 11 depicts a scheme that is used by the electronic device to derive a style to be proposed through an analysis of the image according to an embodiment.

As described above, the electronic device 101 may analyze an image 400 for which a story is to be generated.

The electronic device 101 may generate a semantic graph by analyzing the image 400. The electronic device 101 may utilize the information analyzed in the process of generating the semantic graph.

The electronic device 101 may propose a style 1160 of the story to be generated based on at least one of a scene category 1110, a style category 1120, an emotion category 1130 of a person included in the image, a weather category 1140, or a user preference category 1150.

When a plurality of foods are included in the image, the electronic device 101 may propose a caption or a recommendation based on the scene category 1110 and the user preference category 1150.

The electronic device 101 may propose a style 1160 of the story to be generated by using at least one of a book, a movie, a song, a newspaper article, a writer, or a poem. For example, a favorite movie of the user may be proposed as the style. Specifically, the electronic device 101 may propose the title of a movie. When the user selects the movie, an object included in the image may be changed into an object appearing in the movie. For example, when the style of the movie “Star Wars” is applied to the image 400 in FIG. 4A, a story such as “The sunny weather was suitable for learning sword fighting. Jedi John showed Padawan Mary how to hold a knife correctly. Mary had a birthday like this.” may be generated.

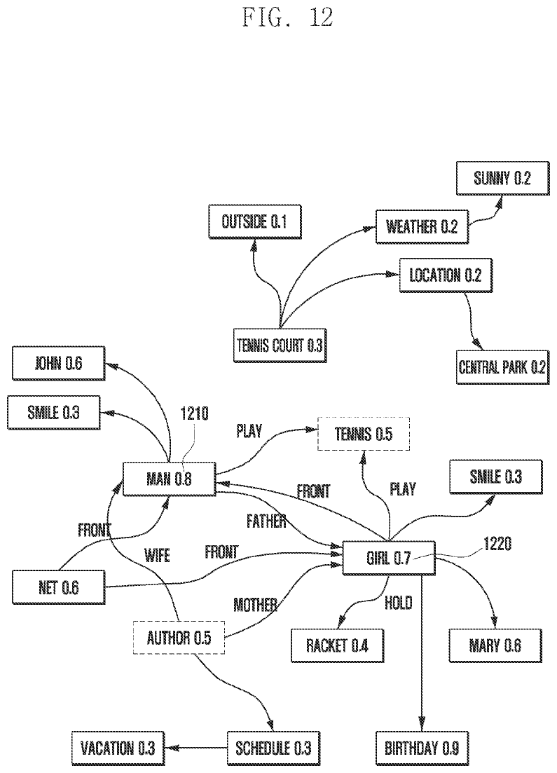

FIG. 12 illustrates a case where weights are considered by the electronic device according to an embodiment.

The electronic device 101 may assign weights 1210 and 1220 to objects (i.e., the man and the girl, respectively) extracted from the image 400.

The weight may be given in consideration of at least one of the style of the story to be generated, the user's selection, or the position, size and type of the object in the image.

The electronic device 101 may generate a story with priority given to objects having a high weight. The electronic device 101 may exclude an object having a weight lower than a preset minimum value in creating a story.

The electronic device 101 may determine the length of a story to be generated in advance. For example, the electronic device 101 may set in advance at least one of the style of the story, the maximum number of sentences, or the maximum number of words.

The electronic device 101 may set the type of a story to be generated. For example, the type of a story to be generated may include a quotation, a short story, and a caption.

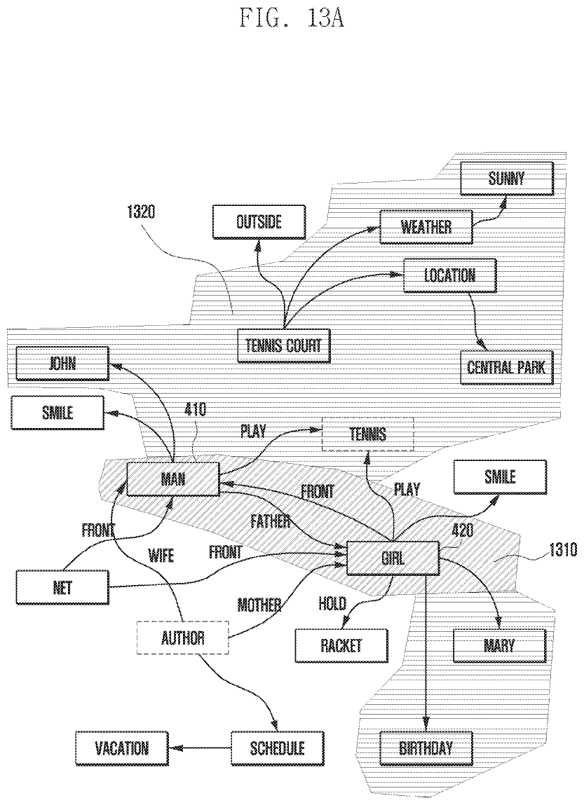

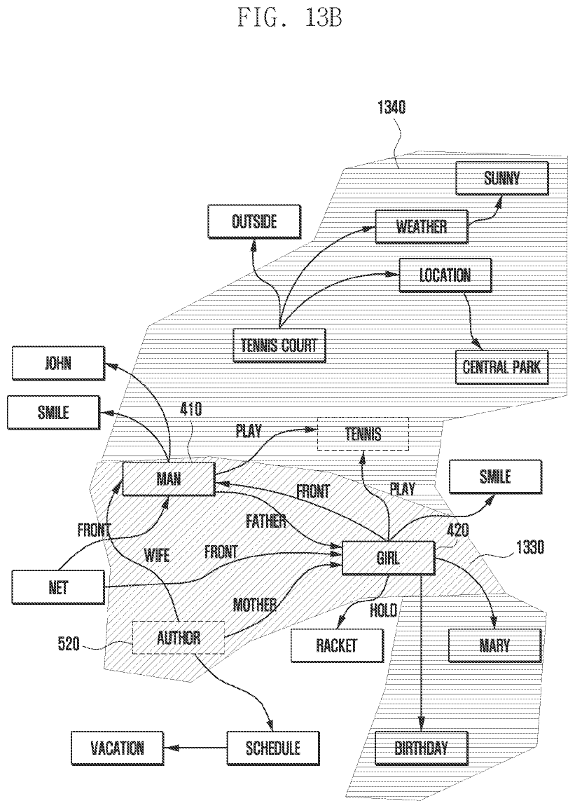

FIGS. 13A and 13B are diagrams in which the electronic device generates various stories according to various embodiments.

The electronic device 101 may generate different stories even for the same image by changing the focus of the story.

The electronic device 101 may select an object to be the focus of the story. The object to be the focus of the story may also be selected by the user. FIG. 13A shows an example in which the focus 1310 of the story is placed on the man 410 and the girl 420. The electronic device 101 may generate the story by use of the information 1320 extracted in relation to the selected object. The electronic device 101 may place the focus 1310 on the selected objects, the man 410 and the girl 420, and may generate a story “John and his daughter Mary are celebrating her birthday in Central Park. The weather is sunny, and they are playing tennis.”

FIG. 13B shows an example in which the focus 1330 of the story is placed on the man 410, the girl 420, and the author 520. The electronic device 101 may place the focus of the story by adding an object not included in the image 400. For example, even if the author 520 is not included in the image 400, the electronic device 101 may further include the author 520 in the focus of the story to be generated. The electronic device 101 may generate the story by use of the information 1340 extracted in relation to the selected objects, the man 410, the girl 420, and the author 520. For example, the electronic device 101 may place a focus on the selected objects, the man 410, the girl 420, and the author 520 and generate a story “We went to Central Park to celebrate Mary's birthday. It was warm and sunny. John and Mary played tennis.”

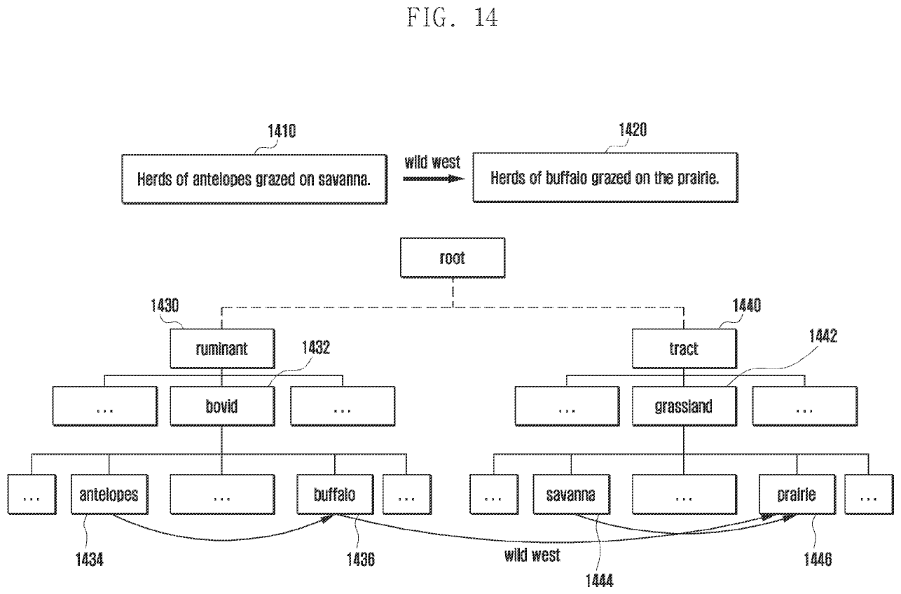

FIG. 14 shows an example of changing a generated story into a selected style according to an embodiment.

With reference to FIG. 14, the electronic device 101 may generate a story “Herds of antelopes grazed on savanna.” (1410) from a specific image. Thereafter, if the user selects “wild west” as the style of the story to be generated, the electronic device 101 may change the generated story into the “wild west” style.

The electronic device 101 may use a parse tree to change the generated story. As the place of antelopes 1434 in the generated story is the place of a noun in terms of syntax, the electronic device 101 may select a noun of the “wild west” style that can replace antelopes 1434. For example, as antelopes 1434 belong to the bovid family 1432 among ruminant animals 1430, the electronic device 101 may select buffalo 1436 among animals belonging to the bovid family 1432 for the “wild west” style.

The electronic device 101 may also change savanna 1444 of the generated story into the “wild west” style. Likewise, as the place of savanna 1444 is also the place of a noun in syntax, the electronic device 101 may select a noun of the “wild west” style that can replace savanna 1444. For example, as savanna 1444 belongs to grassland 1442 among tract 1440, the electronic device 101 may select prairie 1446 among regions belonging to grassland 1442 for the “wild west” style.

The electronic device 101 may generate a story “Herds of antelopes grazed on savanna.” (1410) from the image and may obtain another story “Herds of buffalo grazed on the prairie.” (1420) by changing the original story into the “wild west” style.

FIG. 14 shows an example of changing only some nouns to the selected style, but verbs may also be changed to the selected style. The electronic device 101 may further include a database to change the style. To change the style of the story, the electronic device 101 may use not only the internal database but also an external cloud server.

Various embodiments of the disclosure may be used in social networks, galleries, Bixby Vision, augmented reality (AR), advertisements, and personal assistants. For example, when a social network uploads an image, a story may be created and uploaded together with the image. As another example, it is possible to generate an attractive story through a user's query.

According to an embodiment, an electronic device may include a processor configured to extract objects from at least one image and/or video; analyze information related to the objects extracted from the at least one image and/or video; select the style of a story to be generated based on the extracted objects and the analyzed information; generate the story by using the extracted objects and the analyzed information; and change an object included in the generated story into the selected style.

The processor may be further configured to assign weights to the extracted objects and the analyzed information; and generate a story by further considering the assigned weights.

The processor may be further configured to add a new object in addition to the extracted objects; and generate a story by further considering the new object.

The processor may be further configured to generate a story by further considering information on applications related to the objects.

The processor may be further configured to further analyze at least one of a positional relationship, an emotional relationship, or a subjective relationship between the extracted objects.

The processor may be further configured to further analyze at least one of a scene or a context of the at least one image and/or video; and generate a story by further considering information related to the analyzed scene.

If a video is included in the target from which objects are extracted, the processor may be further configured to further analyze a sound included in the video; and generate a story by further considering information related to the analyzed sound.

The processor may be further configured to generate a story by using at least some of plural sentences stored in a database.

According to an embodiment, an electronic device may include a processor configured to extract objects from at least one image and/or video; analyze information related to the objects extracted from the at least one image and/or video; select the style of a story to be generated based on the extracted objects and the analyzed information; change the extracted objects and the analyzed information into the selected style; and generate the story by using the changed objects and information.

The processor may be further configured to generate a story by using at least some of plural sentences stored in a database.

According to an embodiment, a story generation method of an electronic device may include extracting objects from at least one image and/or video; analyzing information related to the objects extracted from the at least one image and/or video; selecting the style of a story to be generated based on the extracted objects and the analyzed information; generating the story by using the extracted objects and the analyzed information; and changing an object included in the generated story into the selected style.

The story generation method of the electronic device may further include assigning weights to the extracted objects and the analyzed information, wherein generating the story may include generating a story by further considering the assigned weights.

The story generation method of the electronic device may further include adding a new object in addition to the extracted objects, wherein generating the story may include generating a story by further considering the new object.

In the story generation method of the electronic device, generating the story may include generating a story by further considering information on applications related to the objects.

In the story generation method of the electronic device, analyzing information related to the objects extracted from the at least one image and/or video may include analyzing at least one of a positional relationship, an emotional relationship, or a subjective relationship between the extracted objects.

The story generation method of the electronic device may further include analyzing at least one of a scene or a context of the at least one image and/or video, wherein generating the story may include generating a story by further considering information related to the analyzed scene.

The story generation method of the electronic device may further include analyzing, if a video is included in the target from which objects are extracted, a sound included in the video, wherein generating the story may include generating a story by further considering information related to the analyzed sound.

In the story generation method of the electronic device, generating the story may include generating a story by using at least some of plural sentences stored in a database.

According to an embodiment, a story generation method of an electronic device may include extracting objects from at least one image and/or video; analyzing information related to the objects extracted from the at least one image and/or video; selecting the style of a story to be generated based on the extracted objects and the analyzed information; changing the extracted objects and the analyzed information into the selected style; and generating the story by using the changed objects and information.

In the story generation method of the electronic device, generating the story may include generating a story by using at least some of plural sentences stored in a database.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

A method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been particularly shown and described with reference to certain embodiments thereof, it will be understood by those skilled in the art that various changes in form and details may be made therein without departing from the scope of the subject matter as defined by the appended claims and their equivalents.

What is claimed is:

1. An electronic device comprising a processor, wherein the processor is configured to:
extract objects from at least one image and/or video;
analyze information related to the objects extracted from the at least one image and/or video;
select a style of a story to be generated based on the extracted objects and the analyzed information;
generate the story by using the extracted objects and the analyzed information; and
change an object included in the generated story into the selected style.

2. The electronic device of claim 1, wherein the processor is further configured to:
assign weights to the extracted objects and the analyzed information; and
generate a story by considering the assigned weights.

3. The electronic device of claim 1, wherein the processor is further configured to:
add a new object in addition to the extracted objects; and
generate a story by considering the new object.

4. The electronic device of claim 1, wherein the processor is further configured to generate a story by considering information on applications related to the objects.

5. The electronic device of claim 1, wherein the processor is further configured to analyze at least one of a positional relationship, an emotional relationship, or a subjective relationship between the extracted objects.

6. The electronic device of claim 1, wherein the processor is further configured to:
analyze at least one of a scene or a context of the at least one image and/or video; and
generate a story by considering information related to the analyzed scene.

7. The electronic device of claim 1, wherein, in case that a video is included in a target from which objects are extracted, the processor is further configured to:
analyze a sound included in the video; and
generate a story by considering information related to the analyzed sound.

8. The electronic device of claim 1, wherein the processor is further configured to generate a story by using at least some of plural sentences stored in a database.

9. An electronic device comprising a processor, wherein the processor is configured to:
extract objects from at least one image and/or video;
analyze information related to the objects extracted from the at least one image and/or video;
select a style of a story to be generated based on the extracted objects and the analyzed information;
change the extracted objects and the analyzed information into the selected style; and
generate the story by using the changed objects and information.

10. The electronic device of claim 9, wherein the processor is further configured to generate a story by using at least some of plural sentences stored in a database.

11. A method of story generation for an electronic device, the method comprising:
extracting objects from at least one image and/or video;
analyzing information related to the objects extracted from the at least one image and/or video;
selecting a style of a story to be generated based on the extracted objects and the analyzed information;
generating the story by using the extracted objects and the analyzed information; and
changing an object included in the generated story into the selected style.

12. The method of claim 11, further comprising assigning weights to the extracted objects and the analyzed information, and generating the story by considering the assigned weights.

13. The method of claim 11, further comprising adding a new object in addition to the extracted objects, and generating the story by considering the new object.

14. The method of claim 11, further comprising generating the story by considering information on applications related to the objects.

15. The method of claim 11, further comprising analyzing at least one of a positional relationship, an emotional relationship, or a subjective relationship between the extracted objects.

16. The method of claim 11, further comprising analyzing at least one of a scene or a context of the at least one image and/or video, and generating the story by considering information related to the analyzed scene.

17. The method of claim 11, further comprising analyzing, in case that a video is included in a target from which objects are extracted, a sound included in the video, and generating the story by considering information related to the analyzed sound.

18. The method of claim 11, further comprising generating the story by using at least some of plural sentences stored in a database.
